(19) United States
(12) Patent Application Publication
(10) Pub. No.: US 2007/0033027 A1
(43) Pub. Date: Feb. 8, 2007

(54) SYSTEMS AND METHODS EMPLOYING STOCHASTIC BIAS COMPENSATION AND BAYESIAN JOINT ADDITIVE/CONVOLUTIVE COMPENSATION IN AUTOMATIC SPEECH RECOGNITION

(75) Inventor: Kaisheng N. Yao, Dallas, TX (US)

Correspondence Address: TEXAS INSTRUMENTS INCORPORATED, P O BOX 655474, M/S 3999, DALLAS, TX, 75265, US

(73) Assignee: Texas Instruments, Incorporated, Dallas, TX (US)

(21) Appl. No.: 11/278,877

(22) Filed: Apr. 6, 2006

Related U.S. Application Data
(63) Continuation-in-part of application No. 11/195,895, filed on Aug. 3, 2005.

(51) Int. Cl. G10L 15/20

(52) U.S. Cl. 704/233

(57) ABSTRACT

A system for, and method of, noisy automatic speech recognition (ASR) and a digital signal processor (DSP) incorporating the system or the method. In one embodiment, the system includes: (1) a background noise estimator configured to generate a current background noise estimate from a current utterance, (2) an acoustic model compensator associated with the background noise generator and configured to use a previous channel distortion estimate and the current background noise estimate to compensate acoustic models and recognize a current utterance in the speech signal, (3) an utterance aligner associated with the acoustic model compensator and configured to align the current utterance using recognition output, (4) a channel distortion estimator associated with the utterance aligner and configured to generate a current channel distortion estimate from the current utterance and (5) a bias estimator associated with the channel distortion estimator and configured to estimate at least one cluster-dependent bias term using a previous channel distortion estimate and the current background noise estimate.

### CROSS-REFERENCE TO RELATED APPLICATIONS

The present invention is a continuation-in-part of, and claims priority based on, U.S. patent application Ser. No. 11/195,895 by Yao, entitled “System and Method for Noisy Automatic Speech Recognition Employing Joint Compensation of Additive and Convolutive Distortions,” filed Aug. 3, 2005, and is further related to U.S. patent application Ser. No. 11/196,601 by Yao, entitled “System and Method for Creating Generalized Tied-Mixture Hidden Markov Models for Automatic Speech Recognition,” filed Aug. 3, 2005, commonly assigned with the present invention and incorporated herein by reference.

### TECHNICAL FIELD OF THE INVENTION

The present invention is directed, in general, to automatic speech recognition (ASR) and, more specifically, to systems and methods employing stochastic bias compensation and Bayesian joint additive/convolutive compensation in ASR.

### BACKGROUND OF THE INVENTION

Over the last few decades, the focus in ASP has gradually shifted from laboratory experiments performed on carefully enunciated speech received by high-fidelity equipment in quiet environments to real applications having to cope with normal speech received by low-cost equipment in noisy environments.

In such situations, an ASR system may often be required to work with mismatches conditions between pre-trained speaker-independent acoustic models and a speaker-dependent voice signal. Mismatches are often caused by environmental distortions. Environmental distortions may be additive in nature—background noise, such as a computer fan, a car engine or road noise (see, e.g., Gong, “A Method of Joint Compensation of Additive and Convolutive Distortions for Speaker-Independent Speech Recognition,” IEEE Trans. on Speech and Audio Processing, vol. 13, no. 5, pp. 975-983, 2005). Environmental distortions may be convolutive in nature—changes in microphone type (e.g., a hand-held microphone or a hands-free microphone) or position relative to the speaker's mouth, which determines the envelope of the speech spectrum. Speaker-dependent characteristics, such as variations in vocal tract geometry, introduce mismatches. These mismatches tend to degrade the performance of an ASR system dramatically. In mobile ASR applications, these distortions occur routinely. Therefore, a practical ASR system needs to be able to operate successfully despite these distortions.

Hidden Markov models (HMMs) are widely used in the current ASR systems. The above distortion may affect HMMs in many aspects. Among them, shift of mean vectors, or additional biases to the pre-trained mean vectors, is a major effect. Many techniques have been developed in an attempt to compensate for these distortions. Generally, the techniques may be classified into two approaches: front-end techniques that recover clean speech from a noisy observation (see, e.g., ETSI, “Evaluation of a Noise-Robust DSR Front-End on Aurora Databases,” in ICSLP, 2002, vol. 1, pp. 17-20, Acero, et al., Environmental Robustness in Automatic Speech Recognition, in ICASSP, 1990, vol.2, pp. 849-852, Deng, et al., “Recursive Estimation of Nonstationary Noise Using Iterative Stochastic Approximation for Robust Speech Recognition,” IEEE Trans. on Speech and Audio Processing, vol. 11, no. 6, pp. 568-580, 2003, Moreno, et al., “A Vector Taylor Series Approach for Environment-Independent Speech Recognition,” in ICASSP, 1996, vol. 2, pp. 733-736, Hermansky, et al., “Rasta-PLP Speech Analysis Technique,” in ICASSP, 1992, pp. 121-124, Rahim, et al., “Signal Bias Removal by Maximum Likelihood Estimation for Robust Telephone Speech Recognition,” IEEE Trans. on Speech and Audio Processing, vol. 4, no. 1, pp. 19-30, January 1996, and Hilger, et al., “Quantile Based Histogram Equalization for Noise Robust Speech Recognition,” in EUROSPEECH, 2001, pp. 1135-1138) and back-end techniques that adjust model parameters to better match the distribution of a noisy speech signal (see, e.g., Gales, et al., “Robust Speech Recognition in Additive and Convolutional Noise Using Parallel Model Combination,” Computer Speech and Language, vol. 9, pp. 289-307, 1995, Sankar, et al., “A Maximum-Likelihood Approach to Stochastic Matching for Robust Speech Recognition,” IEEE Trans, on Speech and Audio Processing, vol. 4, no. 3, pp. 190-201, 1996, Yao, et al., “Noise Adaptive Speech Recognition Based on Sequential Noise Parameter Estimation,” Speech Communication, vol. 42, no. 1, pp. 5-23, 2004, Zhao, “Maximum Likelihood Joint Estimation of Channel and Noise for Robust Speech Recognition,” in ICASSP, 2000, vol. 2, pp. 1109-1113, Woodland, et al., “Improving Environmental Robustness in Large Vocabulary Speech Recognition,” in ICASSP, 1996, pp. 65-68, and Chou, “Maximum a Posterior Linear Regression based Variance Adaptation of Continuous Density HMMs,” Technical Report ALR-2002-045, Avaya Labs Research, 2002).

Usually, back-end techniques adapt original acoustic models with a few samples from a testing speech signal. The adaptation may be done parametrically with a parametric mismatch function that combines clean speech and distortion. For example, parallel model combination, or PMC (see, e.g., Gales, et al., supra) transforms original acoustic model by combining clean speech mean vectors with those from noise samples. Adaptation may also be done without a parametric mismatch function, instead applying linear regression on noisy and original observations with some optimization criteria. For example, maximum-likelihood linear regression, or MLLR (see, e.g., Woodland, et al., supra), estimates cluster-dependent linear transformations by increasing likelihood of noisy signal given the original acoustic models and the transformations. These linear regression methods are more general than the above-described parametric methods such as PMC, as the linear regression methods can deal with distortion other than that is modeled by the parametric mismatch function used, for example, in PMC. However, to achieve reliable regressions, sufficient data may be required in these linear-regression based techniques. In mobile application of ASR, since it is not realistic to obtain enough adaptation data due to frequent changes of testing environment, the parametric methods such as PMC are more often used than the regression methods such as MLLR.

While techniques employing explicit mismatch functions often require relatively few adaptation utterances to transform acoustic models reliably, they have so far proven unable to deal with other types of distortion in speech recognition, such as mismatches caused by accent, etc, which are difficult to be modeled with a precise parametric function describing their effects on speech recognition. Notice that mobile devices are used widely in a variety of environments, which may have distortions caused not only by background noise and convolutive channel distortions, but also by changes of speakers and different accents. Such devices often contain a digital signal processor (DSP).

Accordingly, what is needed in the art are systems and methods based on improved techniques, applicable to ASR, for providing compensation for a wide variety of mismatch. The improved techniques may combine the parametric methods and the linear regression methods and should compensate background noise, channel distortion and other types of distortion jointly. The systems and methods should be adaptable for use in platforms in which computing resources are limited, such as mobile communication devices.

### SUMMARY OF THE INVENTION

To address the above-discussed deficiencies of the prior art, the present invention provides improved techniques, applicable to ASR, for providing compensation for mismatch.

The foregoing has outlined features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a high-level schematic diagram of a wireless telecommunication infrastructure containing a plurality of mobile telecommunication devices within which the system and method of the present invention can operate;

FIG. 2 illustrates a high-level block diagram of a DSP located within at least one of the mobile telecommunication devices of FIG. 1 and containing one embodiment of a system for noisy ASR constructed according to the principles of the present invention;

FIG. 3 illustrates a binary regression tree for cluster-dependent bias removal;

FIG. 4 illustrates a flow diagram of one embodiment of a method of performing stochastic bias compensation carried out according to the principles of the present invention;

FIG. 5 illustrates a flow diagram of one embodiment of a method of performing Bayesian joint additive/convolutive compensation carried out according to the principles of the present invention;

FIG. 6 illustrates a graphical representation of experimental results, namely the log-likelihood of one ASR session in a parked condition; and

FIG. 7 illustrates a graphical representation of experimental results, namely word error rates (WERs) achieved by the stochastic bias compensation technique described herein and other techniques employing a forgetting factor ρof 1.0.

### DETAILED DESCRIPTION

Two related techniques applicable to ASR for providing back-end compensation for mismatch, caused by, for example, environmental effects, will be described herein. The first is called “stochastic bias compensation,” or SEC, and the second is called “Bayesian joint additive/convolutive compensation,” or B-IJAC. An exemplary environment and system within which the two techniques may be carried out will first be described. Then, various embodiments of each technique will be described. Finally, experiments will be set forth regarding the performance of SEC and B-IJAC.

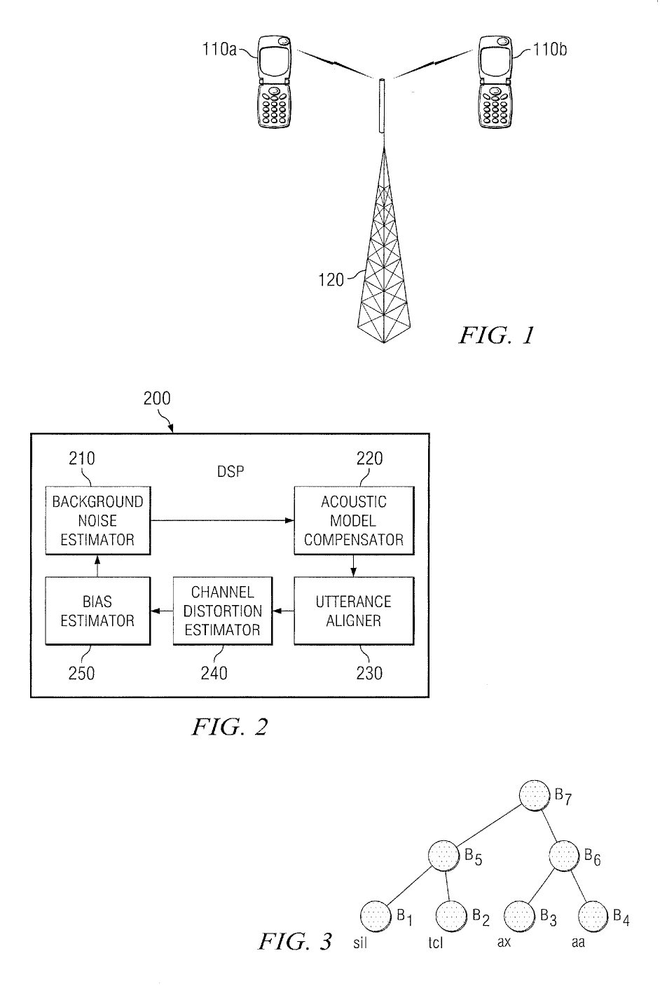

Accordingly, referring to FIG. 1, illustrated is a high level schematic diagram of a wireless telecommunication infrastructure, represented by a cellular tower 120, containing a plurality of mobile telecommunication devices 110a, 110b within which the system and method of the present invention can operate.

One advantageous application for the system or method of the present invention is in conjunction with the mobile telecommunication devices 110a, 110b. Although not shown in FIG. 1, today's mobile telecommunication devices 110a, 110b contain limited computing resources, typically a DSP, some volatile and nonvolatile memory, a display for displaying data and a keypad for entering data.

Certain embodiments of the present invention described herein are particularly suitable for operation in the DSP. The DSP may be a commercially available DSP from Texas Instruments of Dallas, Tex. An embodiment of the system in such a context will now be described.

Turning now to FIG. 2, illustrated is a high-level block diagram of a DSP located within at least one of the mobile telecommunication devices of FIG. 1 and containing one embodiment of a system for noisy ASR constructed according to the principles of the present invention. Those skilled in the pertinent art will understand that a conventional DSP contains data processing and storage circuitry that is controlled by a sequence of executable software or firmware instructions. Most current DSPs are not as computationally powerful as microprocessors. Thus, the computational efficiency of techniques required to be carried out in DSPs in real-time is a substantial issue.

The system includes a background noise estimator 210. The background noise estimator 210 is configured to generate a current background noise estimate from a current utterance. The system further includes an acoustic model compensator 220. The acoustic model compensator 220 is associated with the background noise estimator 210 and is configured to use a previous channel distortion estimate and the current background noise estimate to compensate acoustic models and recognize a current utterance in the speech signal.

The system further includes an utterance aligner 230. The utterance aligner 230 is associated with the acoustic model compensator 220 and is configured to align the current utterance using recognition output. The system further includes a channel distortion estimator 240. The channel distortion estimator 240 is associated with the utterance aligner and is configured to generate a current channel distortion estimate from the current utterance.

The system further includes a bias estimator 250. The bias estimator 250 is associated with the utterance aligner 230, the noise estimator 210 and the channel estimator 240 and is configured to generate estimates of bias terms from the current utterance. Once the bias estimator 250 has generated the bias term estimates, the next utterance is analyzed whereupon the background noise estimator 210 regards the just-generated current channel distortion estimate as the previous channel distortion estimate and the just-generated bias terms estimates as the previous estimates of bias terms and the process continues through a sequence of utterances.

Stochastic Bias Compensation

SBC is a back-end model transformation technique for decreasing mismatch between a testing speech signal and trained acoustic models applied to robust ASR. SBC in uses a parametric function to model environmental distortion, such as background noise and channel distortion, and a cluster-dependent bias to model other types of distortion.

Effects of channel distortion and background noise on mean vectors of clean speech are modeled with a parametric mismatch function, and these distortions are estimated from noisy speech. In addition, biases to the compensated mean are introduced to account for possible other distortions that are not well modeled by the parametric mismatch function. These biases are phonetically clustered. In some embodiments, an E-M-type algorithm may be used to estimate channel distortion, background noise and the biases jointly.

SBC is based on two assumptions. The first assumption is that environmental effects on clean MFCC features can be represented as a non-linear mismatch function (see, e.g., Acero, supra, Gales, et al., supra, and Yao, et al., supra) . The second assumption is that other distortion may be represented as an additional bias. Based upon these two assumptions, the observation in the log-spectral domain is represented as two terms as follows:
Y^{l}(k)=g(X^{l}(k),H^{l}(k),N^{l}(k))+C⁻¹B(k), (1)
where the first term, g(X^{l}(k),H^{l}(k),N^{l}(k)), is:
g(X^{l}(k),H^{l}(k),N^{l}(k))=log(exp(X¹(k)+H^{l}(k))+exp(N^{l}(k))), (2)
and X^{l}(k), H¹(k) and N^{l}(k) respectively denote clean speech, channel distortion and noise in the log-spectral domain. The superscript l denotes the log-spectral domain. The second term, B(k), is a bias term that represents effects due to other distortions. C⁻¹ denotes an inverse Cosine transformation. Feature vectors are implicitly assumed in the cepstral domain. Hence the superscript denoting the cepstral domain is ignored herein.

The goal is to derive a segmental algorithm for estimating statistics of H^{l}(k), N^{l}(k) and B(k) and compensating for their effects on clean MFCC feature vectors. Acoustic models are continuous-density hidden Markov models (CD-HMMs), represented as Λ_{X}={{π_{q}, a_{qq}, c_{qp}, μ_{qp}, Σ_{qp}}: q,q^{′}=1 . . . S,p=1 . . . M}, where μ_{qp} has elements {μ_{qpd}:d=1 . . . D} and Σ_{qp} has elements {σ²_{qpd}:d=1 . . . D}. The acoustic model is trained on clean MFCC feature vectors.

Let R be the number of utterances available for estimating distortion factors. Let Kᵣ be the number of frames in utterance r. m denotes a mixture component in state s. Let S={Sk} and L={mₖ} be the state and mixture sequences corresponding to the observation sequence Yᵣ(1:Kᵣ) for utterance r. The Bayesian estimates or maximum a posteriori probability (MAP) estimates of channel distortion can be written below as

$${H}_{MAP}^{l} = arg {max}_{{H}^{l}} {\sum }_{r = 1}^{R} {\sum }_{S} {\sum }_{L} p ( {Y}_{r} ( 1 \text{:} {K}_{r} ) , S , L \text{\textbar} {H}^{l} , {N}^{l} , B , {Λ}_{X} ) p ( {H}^{l} ) . \qquad ( 3 )$$

Because of the hidden nature of the state and mixture occupancy in HMMs, the MAP optimization problem described in Equation (3) is difficult to solve directly, particularly in view of the limited resources of a mobile communication device. Fortunately, the problem can be more readily solved indirectly using an iterative algorithm called Expectation-Maximization (E-M) (see, e.g., Dempster, et al., “Maximum Likelihood from Incomplete Data Via the E-M Algorithm,” J. Royal Stat. Soc., vol. 39, no. 1, pp. 1-38, 1977) by maximizing the auxiliary function:
Q^{(R)}(H^{l}| H̅^{l})=E{log p(Yᵣ(1:Kᵣ),S,L|H^{l}, N^{l},B,Λ_{X})+log(p(H^{l})|Yᵣ(1:Kᵣ) H̅^{l},Λ_{X})}, (4)
where H^{l} is the channel estimate from the previous E-M iteration.

The first (E) step of the E-M algorithm involves deriving the right-hand side of Equation (4). The second (M) step of the E-M algorithm involves deriving H^{l} such that Q^{(R)}(H^{l}| H̅^{l}) is maximized. By iteratively applying the E and M steps in turn, a sequence of channel estimates can be obtained, leading to a local optimum of Equation (3).

Although channel distortion may be considered slowly varying, background noise may change dramatically from one utterance to the next. Therefore, the well-known maximum likelihood principle may be used in lieu of the above-mentioned MAP estimates to estimate background noise from the current utterance R. The objective function can be written as:

$${N}_{ML}^{l} = arg {max}_{{N}^{l}} {\sum }_{S} {\sum }_{L} p ( {Y}_{R} ( 1 \text{:} {K}_{R} ) , S , L \text{\textbar} {H}^{l} , {N}^{l} , {Λ}_{X} ) \qquad ( 5 )$$

The E-M algorithm may be similarly applied to obtain N^{l}_{ML}. The auxiliary function for noise estimates is:
Q^{(R)}(N^{l}| N̅^{l})=E{log p(Y_{R}(1:K_{R}),S,L|H^{l}, N^{l},Λ_{X})|Y_{R}(1:K_{R}) N̅^{l},Λ_{X})}, (6)
where N̅¹ is the noise estimate from the previous E-M iteration.

Similarly, the bias term B may be estimated by the E-M algorithm with the following auxiliary function:
Q^{(R)}(B^{l}| B̅^{l})=E{log p(Y_{R}(1:K_{R}),S,L|H^{l}, B,Λ_{X})|Y_{R}(1:K_{R}) B̅,Λ_{X})}, (7)
where B̅ is the bias estimate from the previous E-M iteration. The bias term B may be clustered phonetically. Maximizing the above auxiliary function with respect to B obtains the estimate B_{ML}.

To obtain a triplet of (H^{l}_{MAP}, N^{l}_{ML},B_{ML}) that increases the auxiliary functions of Equations (4), (6) and (7), the following approach may be taken. First, N^{l} is fixed equal to N̅^{l} and B is fixed equal to B̅, and Equation (4) is maximized with respect to H^{l} to get H_{MAP}¹. In parallel, N^{l} is fixed equal to N̅^{l} and H^{l} is fixed equal to H̅^{l}, and Equation (7) is maximized with respect to B to get B_{ML}. Then, H^{l} is fixed equal to H_{MAP}^{l} and B is fixed equal to B_{ML}, and Equation (6) is maximized with respect to N^{l} to get N_{ML}^{l}. These three steps can be repeated as desired. This exemplary approach will be described in greater detail below.

The auxiliary function corresponding to the right-hand side of Equation (4) can be rewritten as:

$${Q}^{( R )} ( {H}^{l} \vert {\overline{H}}^{l} ) = {\sum }_{r = 1}^{R} {\sum }_{k = 1}^{{K}_{r}} {\sum }_{s} {\sum }_{m} {γ}_{sm}^{r} ( k ) log p ( {Y}_{r} ( k ) \text{\textbar} {H}^{l} , {N}^{l} , B , {μ}_{sm} , {Σ}_{sm} ) + log p ( {H}^{l} ) , \qquad ( 8 )$$

where the posterior probability γₛₘ ^{r}(k)=p(sₖ=s,mₖ=m)|Yᵣ(1:Kᵣ), H̅^{l}, N̅^{l}, B̅, Λₓ) is also called the “sufficient statistic” of the E-M algorithm.

The variance of a Gaussian density is assumed not to be distorted due to environmental effects. B(k) can therefore be moved to the left-hand side of Equation (1), yielding the following form for p(Yᵣ(k)|sₖ=s,mₖ=m,H^{l}, N^{l}, B, Λ_{X}):
p(Yᵣ(k)|Sₖ=s,mₖ=m,H^{l}, N^{l}B,Λ_{X})=b_{c(sm)}(Yᵣ(k))˜N(Yᵣ(k)−B_{c(sm); \hat{μ}}ₛₘσₛₘ², (9)
where \hat{μ}ₛₘ=g(μₛₘ, H^{l}, N^{l}) is the noisy mean after compensating for environmental distortion, b_{c(sm)} is a cluster-dependent bias term, and c(sm) determines the cluster for state Sₖ=S and mixture mₖ=m.

As is usual in MAP estimation, the choice of the prior density p(H^{l}) may be based on either some physical characteristics of the channel distortion H^{l} or on some attractive mathematical attribute, such as the existence of conjugate prior densities, which can greatly simplify the maximization of Equation (8) (see, e.g., Gauvain, et al., “Maximum a Posteriori Estimation for Multivariate Gaussian Mixture Observations of Markov Chains,” IEEE Trans. on Speech and Audio Processing, vol. 2, no. 2, pp. 291-298, 1994). Prior densities from a family of elliptically symmetric distributions called “matrix version of multivariate normal prior density,” may be useful (see, e.g., Chou, supra).

One peculiarity of MAP estimation is that the formulation is still valid when the prior density is not a probability density function. The only constraint that the prior density should be a nonnegative function. It is therefore possible to select from many different prior densities as long as good estimates of their location and scale parameters can be derived. Without limiting the scope of the present invention, the following prior density is chosen for use herein:
p(H^{l})˜N(H^{l}; V^{l},W^{l}), (10)
where V^{l} and W^{l} are the prior mean and variance of the channel distortion H^{l}. The motivation to select this density is that its hyper-parameters V^{l} and W^{l} can be derived in a straightforward manner. In particular, V^{l} is selected to be the channel estimates from previous iteration, yielding the following function:
p(H^{l}˜N(H^{l}; H̅^{l}Σ_{H}_{^{l}}), (11)
where Σ_{H}_{^{l}} is the variance of channel distortion.

An iterative technique may be used to estimate channel distortion and thereby maximize Equation (8) with respect to H^{l}. A Gauss-Newton technique may be advantageously used to update the channel distortion estimate due to its rapid convergence rate. Using the Gauss-Newton technique, the new estimate of channel distortion is:

$${H}^{l} = {\overline{H}}^{l} - ɛ \frac{{Δ}_{{H}^{l}} Q ( λ \text{\textbar} \overline{λ} )}{{Δ}_{{H}^{l}}^{2} Q ( λ \text{\textbar} \overline{λ} )} {\vert}_{{H}^{l} = {\overline{H}}^{l}} , \qquad ( 12 )$$

where ε is a factor between 0.0 and 1.0.

Using the chain rule of differentiation, the first-order differentials with respect to channel distortion H^{l} are:

$${Δ}_{{H}^{l}} {Q}^{( R )} ( λ \text{\textbar} \overline{λ} ) = - {\sum }_{r = 1}^{R} {\sum }_{k = 1}^{{K}_{r}} {\sum }_{q} {\sum }_{p} {γ}_{qp}^{r} ( k ) \frac{1}{{σ}_{qp}^{{2}^{l}}} [ {C}^{- 1} {Y}_{r} ( k ) - {C}^{- 1} {B}_{c ( qp )} - g ( {μ}_{qp}^{l} , {H}^{l} , {N}^{l} ) ] {Δ}_{{H}^{l}} g ( {μ}_{qp}^{l} , {H}^{l} , {N}^{l} ) - {βΣ}_{{H}^{l}}^{- 1} ( {H}^{l} - {\overline{H}}^{l} ) , \qquad ( 13 )$$

where β is the weight of the prior density, and σ_{qp}²^{^{l}} is the variance vector in the log-spectral domain. Equation (15), below, gives the first-order differential term Δ_{H}_{^{l}}g(μ_{qp}^{l}, H^{l}, N^{l}).

The second order differentials with respect to the channel distortion H^{l} are:

$${Δ}_{{H}^{l}}^{2} {Q}^{( R )} ( λ \text{\textbar} \overline{λ} ) = - {\sum }_{r = 1}^{R} {\sum }_{k = 1}^{{K}_{r}} {\sum }_{q} {\sum }_{p} {γ}_{qp}^{r} ( k ) \frac{1}{{σ}_{qp}^{2 l}} [ {( {Δ}_{{H}^{l}} g ( {μ}_{qp}^{l} , {H}^{l} , {N}^{l} ) )}^{2} + ( g ( {μ}_{qp}^{l} , {H}^{l} , {N}^{l} ) + {C}^{- 1} {B}_{c ( qp )} - {C}^{- 1} {Y}_{r} ( k ) ) {Δ}_{{H}^{l}}^{2} g ( {μ}_{qp}^{l} , {H}^{l} , {N}^{l} ) ] - {βΣ}_{{H}^{l}}^{- 1} \qquad ( 14 )$$

where, by straightforward algebraic manipulation of Equation (2), the first- and second-order differentials of g(μ_{qp}^{l}, H^{l}, N^{l}) in Equations (13) and (14) are:

$$\begin{matrix}{Δ}_{{H}^{l}} g ( {μ}_{qp}^{l} , {H}^{l} , {N}^{l} ) = \frac{exp ( {H}^{l} + {μ}_{qp}^{l} )}{exp ( {H}^{l} + {μ}_{qp}^{l} ) + exp ( {N}^{l} )} & ( 15 ) \\ {Δ}_{{H}^{l}}^{2} g ( {μ}_{qp}^{l} , {H}^{l} , {N}^{l} ) = {Δ}_{{H}^{l}} g ( {μ}_{qp}^{l} , {H}^{l} , {N}^{l} ) ( 1 - {Δ}_{{H}^{l}} g ( {μ}_{qp}^{l} , {H}^{l} , {N}^{l} ) ) . & ( 16 )\end{matrix}$$

Updating Equations (13) and (14) may be further simplified in consideration of reducing computational costs. Specifically, the variance term in the log-spectral domain is costly to obtain due to heavy transformations between the cepstral and the log-spectral domains. Equations (13) and (14) may be simplified by removing the variance vector in the first terms of Equations (13) and (14); i.e.:

$$\begin{matrix}{Δ}_{{H}^{l}} {Q}^{( R )} ( λ \text{\textbar} \overline{λ} ) = - {\sum }_{r = 1}^{R} {\sum }_{k = 1}^{{K}_{r}} {\sum }_{q} {\sum }_{p} {γ}_{qp}^{r} ( k ) [ {C}^{- 1} {Y}_{r} ( k ) - g ( {μ}_{qp}^{l} , {H}^{l} , {N}^{l} ) - {C}^{- 1} {B}_{qp} ] {Δ}_{{H}^{l}} g ( {μ}_{qp}^{l} , {H}^{l} , {N}^{l} ) - {βΣ}_{{H}^{l}}^{- 1} ( {H}^{l} - {\overline{H}}^{l} ) , & ( 17 ) \\ {Δ}_{{H}^{l}}^{2} {Q}^{( R )} ( λ \text{\textbar} \overline{λ} ) = - {\sum }_{r = 1}^{R} {\sum }_{k = 1}^{{K}_{r}} {\sum }_{q} {\sum }_{p} {γ}_{qp}^{r} ( k ) [ {( {Δ}_{{H}^{l}} g ( {μ}_{qp}^{l} , {H}^{l} , {N}^{l} ) )}^{2} + ( g ( {μ}_{qp}^{l} , {H}^{l} , {N}^{l} ) + {C}^{- 1} {B}_{c ( qp )} - {C}^{- 1} {Y}_{r} ( k ) ) {Δ}_{{H}^{l}}^{2} g ( {μ}_{qp}^{l} , {H}^{l} , {N}^{l} ) ] - {βΣ}_{{H}^{l}}^{- 1} , & ( 18 )\end{matrix}$$

By setting β=0, the above functions correspond to a non-Bayesian joint additive/convolutive compensation technique called “IJAC” (see, U.S. Patent Application Serial No. [Attorney Docket Number TI-39862AA], supra) . A further simplification may arrive at another non-Bayesian joint additive/convolutive compensation technique called “JAC” (Gong, supra) and where Equations (17) and (18) are:

$$\begin{matrix}{Δ}_{{H}^{l}} {Q}^{( R )} ( λ \text{\textbar} \overline{λ} ) = - {\sum }_{r = 1}^{R} {\sum }_{k = 1}^{{K}_{r}} {\sum }_{q} {\sum }_{p} {γ}_{qp}^{r} ( k ) [ g ( {μ}_{qp}^{l} , {H}^{l} , {N}^{l} ) - {C}^{- 1} {Y}_{r} ( k ) ] & ( 19 ) \\ {Δ}_{{H}^{l}}^{2} {Q}^{( R )} ( λ \text{\textbar} \overline{λ} ) = - {\sum }_{r = 1}^{R} {\sum }_{k = 1}^{{K}_{r}} {\sum }_{q} {\sum }_{p} {γ}_{qp}^{r} ( k ) {Δ}_{{H}^{l}} g ( {μ}_{qp}^{l} , {H}^{l} , {N}^{l} ) & ( 20 )\end{matrix}$$

Equations (19) and (20) relate to Equations (17) and (18) with the following four assumptions:
(1) The weight of the prior density β is zero,
(2) Δ_{H}_{^{l}}g(μ_{qp}^{l}, H^{l}, N^{l}) is removed from Equations (17) and (18),
(3) the following function holds:
   1−Δ_{H}_{^{l}}g(μ_{qp}^{l},H^{l}N^{l})<<Δ_{H}_{^{l}}g(μ_{qp}^{l},H^{l},N^{l}), (21)
(4) and the bias term B is zero.

By Equation (15), 1−Δ_{H}_{^{l}}g(μ_{qp}^{l}, H^{l},N^{l})<<Δ_{H}_{^{l}}g(μ_{qp}^{l},H^{l}, N^{l}) is equivalent to exp(N^{l})<<exp(H^{l}+μ_{qp}^{l}), i.e., additive noise power is much smaller than channel distorted speech power.

Some modeling error may arise as a result of some of these simplifications. If so, the updating of Equation (12) may result in a biased estimate of channel distortion. To counter effects due to the simplification, a discounting factor ξ is introduced herein. The discounting factor ξ is multiplied with the previous estimate to diminish its influence. With the discounting factor ξ, the updating function becomes:

$${H}^{l} = ξ {\overline{H}}^{l} - ɛ \frac{{Δ}_{{H}^{l}} Q ( λ \text{\textbar} \overline{λ} )}{{Δ}_{{H}^{l}}^{2} Q ( λ \text{\textbar} \overline{λ} )} {\vert}_{{H}^{l} = ξ {\overline{H}}^{l }} . \qquad ( 22 )$$

In the illustrated embodiment, the discounting factor ξ is not used in calculating the sufficient statistic of the E-M algorithm. Therefore, introduction of discounting factor ξ causes a potential mismatch between the H^{l} used for the sufficient statistic and the H^{l} used for calculating derivatives in g(μ_{qp}^{l}, H^{l}, N^{l}). However, both the modeling error and the potential H^{l} mismatch may be alleviated by choosing ξ carefully. ξ is empirically set to a real number between 0 and 1.

The efficiency of the Bayesian technique used depends upon the quality of the prior density. In the context of SBC, the prior density should reflect the fluctuation of channel distortion H^{l} occurring when environment compensation is conducted for different filter banks. Accordingly, the following estimates are suitable for P(H^{l}):
P(H^{l})=N(H^{l}; H̅^{l},Σ_{H}_{^{l}}), (23)
Σ_{H}_{^{ll}}=E[H^{l}−E(H^{l}))²], (24)
where, in one embodiment, IJAC was used to produce averaged estimates to obtain E(H^{l}).

Background noise is often estimated by averaging non-speech frames in the current utterance. However, since the estimates are not directly linked to trained acoustic models Λ_{X}, the estimates may not be optimal. In addition, since averaging is prone to distortion by statistical outliers occurring at high noise levels, the estimates may not be reliable.

Following the objective function in Equation (5), a technique for achieving reliable noise estimates according to SBC will now be presented. The technique assumes that the beginning frames of the current utterance are background noise and therefore uses these frames to train a silence model. One embodiment of the technique for achieving reliable noise estimates will now be described. First, parameters of the silence model are trained and fixed in a clean acoustic model. Then, Nᵢ^{l} at iteration i=0 is set to be the average noise vector from the beginning non-speech frames of the current utterance. Then, for each iteration i in the noise segments and for frame k=1 to T, the following steps are executed:
Step 1: Set N̅^{l}=Nᵢ^{l}, and compute the posterior probability:

$${γ}_{qp}^{R} ( k ) = \frac{{b}_{qp} ( {Y}_{R} ( k ) ) {c}_{qp}}{{\sum }_{sm} {b}_{sm} ( {Y}_{R} ( k ) ) {c}_{sm}} , \qquad ( 25 )$$

where the likelihood b_{qp}(Y_{R}(k) is computed from Equation (9).
Step 2: Compute the differentials of the auxiliary function of Equation (6), given below as:

$$\begin{matrix}{Δ}_{{N}^{l}} {Q}^{( R )} ( {N}^{l} \text{\vert} {\overline{N}}^{l} ) = {\sum }_{k = 1}^{T} {\sum }_{qp} {γ}_{qp}^{r} ( k ) [ \begin{matrix}{C}^{- 1} {Y}_{R} ( k ) - {C}^{- 1} {B}_{c ( qp )} - \\ g ( {μ}_{qp}^{l} , {H}^{l} , {N}^{l} )\end{matrix} ] {Δ}_{{N}^{l}} g ( {μ}_{qp}^{l} , {H}^{l} , {N}^{l} ) , & ( 26 ) \\ {Δ}_{{N}^{ l}}^{2} {Q}^{( R )} ( {N}^{l} \text{\vert} {\overline{N}}^{l} ) = - {\sum }_{k = 1}^{T} {\sum }_{qp} {γ}_{qp}^{r} ( k ) [ \begin{matrix}{( {Δ}_{{N}^{l}} g ( {μ}_{qp}^{l} , {H}^{l} , {N}^{l} ) )}^{2} + \\ ( \begin{matrix}g ( {μ}_{ qp}^{ l} , {H}^{ l} , {N}^{ l} ) + \\ {C}^{- 1} {B}_{ c ( qp )} - {C}^{- 1} {Y}_{ R} ( k )\end{matrix} ) \\ {Δ}_{{N}^{l}}^{2} g ( {μ}_{qp}^{l} , {H}^{l} , {N}^{l} )\end{matrix} ] & ( 27 )\end{matrix}$$

The first-order differential of Equation (2) with respect to noise N^{l} is related to the channel distortion H^{l} as Δ_{N}_{ⁱ}g(μ_{qp}^{l}, H^{l}, N^{l})=1−Δ_{H}_{^{l}}g(μ_{qp}^{l}, H^{l}, N^{l}). The second-order differential of Equation (2) is Δ_{N}_{^{l}}²g(μ_{qp}^{l}, H^{l},N^{l})=Δ_{N}_{^{l}}g(μ_{qp}^{l},H^{l},N^{l})(1−Δ_{N}g(μ_{qp}^{l},H^{l},N^{l})).
Step 3: Compute:

$${N}_{i + 1}^{l} = {N}_{i}^{l} - α \frac{{Δ}_{{N}^{l}} {Q}^{( R )} ( {N}^{l} \text{\vert} {\overline{N}}^{l} )}{{Δ}_{{N}^{l}}^{2} {Q}^{( R )} ( {N}^{l} \text{\vert} {\overline{N}}^{l} )} , \qquad ( 28 )$$

where α is the step size.
Step 4: Increment i. If i<I (a desired total number of iterations), go back to step 1 with N^{l}=Nᵢ^{l}. Otherwise, Nᵢ^{l} is the noise estimate.

The step size α in Equation (28) controls the updating rate for noise estimation. In various alternative embodiments, the step size α changes depending upon the estimated noise level, the iteration number i or both.

Notice that the illustrated embodiment includes several approximations designed to increase computation speed. These are: (1) the variance of acoustic models is not used (as was the case with channel estimation); (2) the approximation of posterior probabilities is set at either zero or one for each frame k and (3) the estimation of posterior probability of frame k is made without consideration of feature vectors in other frames. Alternative embodiments may omit one or more of these approximations.

Maximizing the auxiliary function of Equation (7) with respect to the bias term B yields the following updating equation:

$${B}_{c ( qp )} = \frac{{\sum }_{r = 1}^{R} {\sum }_{k = 1}^{{K}_{r}} {\sum }_{qp} {γ}_{qp}^{r} ( k ) ( {Y}_{r} ( k ) - {\hat{μ}}_{qp} ) {\sum }_{qp}^{- 1}}{{\sum }_{r = 1}^{R} {\sum }_{k = 1}^{{K}_{r}} {\sum }_{qp} {γ}_{qp}^{r} ( k ) {\sum }_{qp}^{- 1}} \qquad ( 29 )$$

The bias estimation is the same as that in MLLR (see, e.g., Woodland, et al., supra) and therefore can also make use of a binary regression tree. The tree groups Gaussian components in the acoustic models Ax according to their phonetic classes, so that the set of biases to be estimated can be chosen according to:
1. the amount of adaptation data, and
2. the phonetic class of the Gaussian components. FIG. 3 shows an example of the binary regression tree. Leaf nodes B1-B4 correspond to monophones. The leaf nodes B1-B4 are grouped according to their phonetic closeness, which may be assigned subjectively. All nodes B1-B7, including internal nodes B5-B7, have an estimated bias.

One embodiment of the E-M algorithm for estimating the biases is carried out using the following process:
1. E-step: Given an alignment between observed data and the HMMs, obtain posterior probabilities γ_{c(qp)}(k) in the same way as above for the leaf node corresponding to the HMMs. Accumulate sufficient statistics in the upper and lower part of Equation (29) for the corresponding leaf node (e.g., B1). Next, accumulate sufficient statistics for parent nodes (e.g., B5, B7) of the leaf node (e.g., B1).
2. M-step: Update bias estimates if the amount of adaptation for a node is larger than a threshold Dₘᵢₙ.

The above process is a reliable and dynamic way of estimating the biases. If a small amount of data is available, a global bias may be used for every HMM. However, as more adaptation data becomes available, the biases become more ascertainable and therefore may be different for each HMM or group of HMMs.

A forgetting factor ρ may be introduced to force parameter updating with more emphasis on recent utterances. Therefore, the sufficient statistics in Equations (17) and (18) may be weighted by a factor ρ^{R-r}.

The performance of E-M-type algorithms depends upon the sufficient statistic γₛₘ^{r}(k). A forward-backward algorithm (see, e.g., Rabiner,“A Tutorial on Hidden Markov Models and Selected Applications in Speech Recognition”, Prentice Hall P T R, 1993) may be used to obtain the sufficient statistic. State sequences may be obtained from Viterbi alignment during the decoding process. This is usually called “unsupervised estimation” and contrasts with “supervised estimation,” which uses ground-truth state sequence alignments.

The channel and noise distortion factors and cluster-dependent biases are advantageously estimated before recognition of an utterance. The following technique for estimating these factors may be used for the current utterance:
1. The channel distortion H^{l} may be obtained from the previously recognized utterances.
2. The bias terms B_{c(qp)} may be estimated from the previously recognition utterances.
3. The noise estimate may be made from the non-speech segments of the current utterance. The channel distortion and bias terms are initialized to zero for a session. The recognition process does not have to be delayed due to estimation.

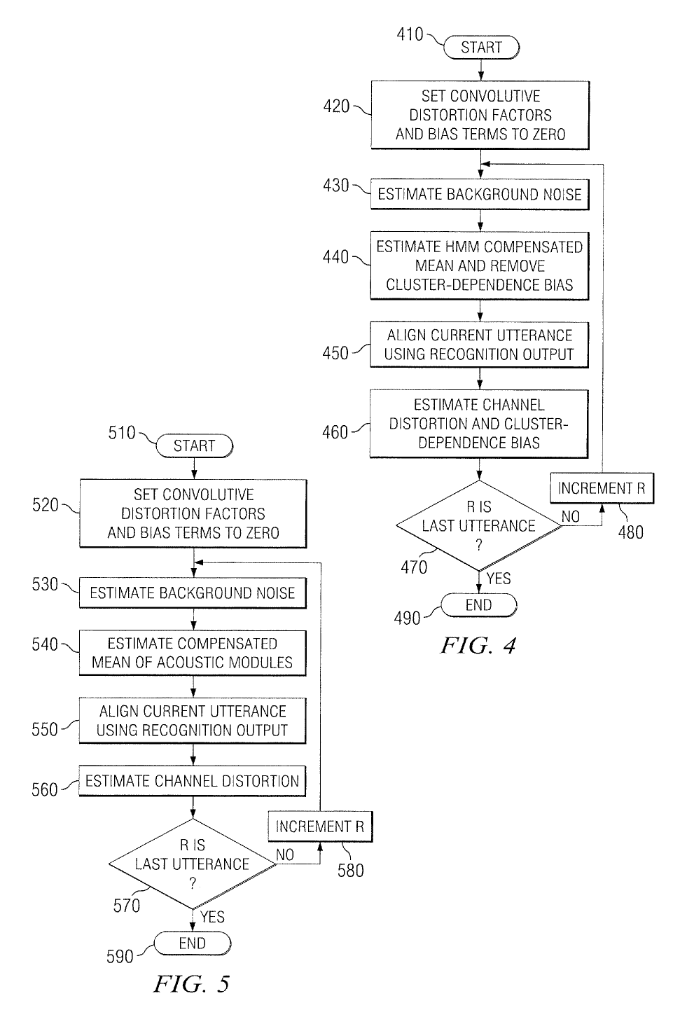

Turning now to FIG. 4, illustrated is a flow diagram of one embodiment of a method of performing SBC for estimating channel and noise distortion factors and cluster-dependent biases carried out according to the principles of the present invention. The method begins in a start step 410 when a sequence of utterances constituting noisy speech is received.
1. Initialize estimates of convolutive distortion factors and bias terms to zero (in a step 420).
2. Estimate background noise from non-speech segments of the current utterance (in a step 430). The first ten frames of input features may be averaged to extract the mean of the frames. The mean may then be used as the background noise estimate N^{l}. The mean may also be used to initialize the maximum likelihood estimate of noise, as described above.
3. Estimate the compensated mean of the acoustic models Λ_{X} using the previously estimated channel distortion and the currently estimated background noise factors (in a step 440). Remove cluster-dependent bias during decoding of the current utterance R with the compensated acoustic model (also in the step 450).
4. Align the current utterance R using recognition output (in a step 450). Obtain sufficient statistics γ_{qp}^{R}(k) for each state q, mixture component p and frame k.
5. Estimate the channel distortion and cluster-dependent bias terms (in a step 460). 6. Determine whether R is the last utterance to recognize (in a decisional step 470). 7. If not, increment R (in a step 480) and go back to step 2 (the step 430) for the next utterance. If so, the method ends in an end step 490.

Bayesian Joint Additive/Convolutive Compensation Having described several embodiments of SBC, several embodiments of Bayesian joint additive/convolutive compensation, or B-IJAC, will now be described. By setting B(k) to 0 in Equation (1), the bias terms in the above described SBC may be ignored. Using the same notation, the noise estimate is obtained via Equations (25) to (28) with the bias term B and B̅ set to 0. The channel estimate is obtained via Equations (12) to (24) with the bias term B and B̅ set to 0. Because the channel estimate uses the prior probability of channel distortion P(H^{l}), the embodiment is called B-IJAC.

Turning now to FIG. 5, illustrated is a flow diagram of one embodiment of a method of performing B-IJAC for estimating channel and noise distortions carried out according to the principles of the present invention. The method begins in a start step 510 when a sequence of utterances constituting noisy speech is received.
1. Initialize estimate of convolutive distortion to zero (in a step 520).
2. Estimate background noise from non-speech segments of the current utterance (in a step 530). Usually, the beginning ten frames of input features are averaged to extract the mean of the frames. The mean is used as the background noise estimate N^{l}. It is also used to initialize the maximum likelihood estimate of noise, described above in Equations (25) to (28) with B_{c(qp)} set to zero.
3. Use the estimate of distortions to compensate acoustic models Λ_{X} and recognize the current utterance R (in a step 540).
4. Align the current utterance R using recognition output (in a step 550). Obtain sufficient statistics γ_{qp}^{R}(k) for each state q, mixture component p and frame k.
5. Estimate the channel distortion (in a step 560).

a. Accumulate sufficient statistics via Equations (17) and (18), but with B_{c(qp)} set to zero.

b. Update channel distortion estimate for the next utterance by Equation (22).
6. Determine whether R is the last utterance to recognize (in a decisional step 570).
7. If not, increment R (in a step 580) and go back to step 2 (the step 530) for the next utterance. If so, the method ends in an end step 590.

Experimental Results

Having described several embodiments of SEC and B-IJAC, several experiments will now be set forth regarding SEC and B-IJAC.

SBC was compared to JAC (Gong, supra), non-Bayesian IJAC and maximum-likelihood bias removal (MLBR) on name recognition under a representative variety of hands-free conditions. ε was fixed at 0.9 for the experiments. A technique called “sequential variance adaptation,” or “SVA” (see, e.g., Cui, et al., “Improvements for Noise Robust and Multi-Language Recognition,” Tech. Rep., Speech Technologies Laboratories, Texas Instruments, 2003), was used together with these techniques to transform the variance of the acoustic models.

A database, called “WAVES,” was used in the experiments. WAVES was recorded in a vehicle using an AKG M2 hands-free distant talking microphone in three recording sessions: parked (engine off), city driving (car driven on a stop-and-go basis), and highway driving (car driven at relatively steady highway speeds). In each session, 20 speakers (ten male, ten female) read 40 sentences each, resulting in 1325 English name utterances.

The baseline acoustic model CD-HMM was a gender-dependent, generative tied-mixture HMM (GTM-HMM) (U.S. Patent Application Serial No. 11/196,601, supra), trained in two stages. The first stage trained the acoustic model from the Wall Street Journal (WSJ) with a manual dictionary. Decision-tree-based state tying was applied to train the acoustic model. As a result, the model had one Gaussian component per state and 9573 mean vectors. In the second stage, a mixture-tying mechanism was applied to tie mixture components from a pool of Gaussian densities. After the mixture tying, the acoustic model was re-trained using the WSJ database.

FIG. 6 plots the log-likelihood of one session in the parked condition. ξ=0.7. Tₘᵢₙ=50. A solid-line curve 610 the log-likelihood with SVA and IJAC noise compensation. A broken-line curve 620 is the log-likelihood with SBC. The majority of the increase of the log-likelihood occurred after the first utterance due to the on-line estimates of environmental distortion; the log-likelihood increased from below −35 to around −30. SBC exhibits a higher log-likelihood than IJAC alone. With SEC, the log-likelihood after the first utterance exceeded −30 in most utterances.

Table 1, below, shows recognition results by SBC, together with those by MLLR and IJAC. MLLR was implemented without rotation of mean vectors. Nevertheless, the MLLR implementation applied phonetic clustering. Interestingly, the widely used maximum-likelihood signal bias removal technique (see, e.g., Rahim, et al., supra) may be considered as a special case of the MLLR with only one cluster.

TABLE 1
WER of WAVES Name Recognition

| | WER (in %) | | |
|---|---|---|---|
| | Parked | City Driving | Highway Driving |
| Baseline | 2.2 | 50.2 | 82.9 |
| MLLR (w/o SVA) | 0.28 | 10.35 | 80.15 |
| SBC (w/o SVA) | 0.24 | 0.31 | 3.68 |
| MLLR | 0.31 | 2.99 | 64.66 |
| IJAC | 0.20 | 0.96 | 3.20 |
| SBC | 0.22 | 0.22 | 2.83 |

From Table 1, it may be observed that:
The baseline without noise compensation performed badly under noisy (city driving and highway driving) conditions.
“MLLR (w/o SVA)” improved performance by removing cluster-dependent biases. WER was decreased under all three driving conditions compared to the baseline. Compared to the baseline, WER was reduced 56.7%.
SBC was able to further reduce WER under all three driving conditions. For example, “SEC (w/o SVA)” decreased WER from 80.2% by “MLLR (w/o SVA)” to 3.7% under the highway driving condition. In an average of all three driving conditions, better than 68.9% relative WER reduction was achieved compared to “MLLR (w/o SVA).”
Variance compensation by SVA was helpful in decreasing WERs further. “MLLR” (with SVA) reduced WER relative to “MLLR (w/o SVA)” by 26.6%, and “SEC” (with SVA) reduced WER relative to “SBC (w/o SVA)” by 20.2%.
“SBC” performed better than “IJAC” which used IJAC together with SVA. Relative WER reduction was more than 26%.
Compared to “MLLR”, which applied cluster-dependent bias removal and variance compensation by SVA, “SBC” reduced WER by more than 72.4%.

Next, interference was added to the speech by introducing different levels of background conversation, or “babble” noise, to the WAVES name database under the parked condition. The total number of utterances was 1450. Table 2, below, shows the results of different techniques in babble noise.

TABLE 2
WER of WAVES Name Recognition in Babble Noise

| | WER (in %) | | | | |
|---|---|---|---|---|---|
| | 20 dB | 15 dB | 10 dB | 5 dB | 0 dB |
| Baseline | 5.2 | 19.5 | 51.9 | 80.6 | 92.1 |
| MLLR (w/o SVA) | 0.4 | 14.9 | 30.4 | 82.7 | 91.9 |
| SBC (w/o SVA) | 0.4 | 0.5 | 0.9 | 1.7 | 7.5 |
| MLLR | 0.4 | 6.6 | 35.1 | 92.3 | 97.7 |
| IJAC | 0.4 | 0.4 | 0.9 | 2.4 | 9.8 |
| SBC | 0.2 | 0.5 | 0.6 | 1.7 | 6.6 |

From Table 2, it may be observed that:
The baseline without noise compensation performed badly in noisy (city driving and highway driving) conditions.
“MLLR (w/o SVA)” decreased WERs relative to “baseline” under all noise levels.
SBC was able to further reduce WERs under all three driving conditions. For example, “SBC (w/o SVA)” significantly decreased WER from 91.9o by “MLLR (w/o SVA)” to 7.5% with OdB babble noise. Average WER reduction relative to “MLLR (w/o SVA)” was 76.2%.
Variance compensation by SVA was helpful to decrease WERs further. With SVA, “MLLR” reduced WER relative to “MLLR (w/o SVA)” by 2.9%, and “SBC” reduced WER relative to “SBC (w/o SVA)” by 19.8%.
“SBC” performed better than “IJAC.” Relative WER reduction was more than 24.2%.
Compared to “MLLR”, which applied cluster-dependent bias removal and variance compensation by SVA, “SEC” achieved more than 84.9% relative WER reduction.

Next, SEC was implemented in an embedded speech recognition system. The acoustic model used was a single-mixture-per-state, intra-word triphone model trained from the WSJ database. As before, three driving conditions—highway driving, city driving and parked conditions—were used in the experiment. SBC's performance under the three different driving conditions, together with those achieved by other techniques are shown in Table 3, below.

TABLE 3
WER of WAVES Name Recognition

| | WER (in %) | | |
|---|---|---|---|
| | Highway Driving | City Driving | Parked |
| JAC | 8.6 | 3.7 | 1.4 |
| IJAC | 7.7 | 3.2 | 1.2 |
| B-IJAC | 7.0 | 2.9 | 1.3 |
| SBC | 5.4 | 1.8 | 1.0 |

Compared to JAC, SBC's average WER reduction was 39%.

SEC was implemented in fixed-point C for an embedded ASR system. In a live-mode recognition experiment, fixed-point SEC obtained the results given in Table 4, below.

TABLE 4
WER of WAVES Name Recognition
Achieved by Fixed-Point SBC

| | Hands-free | Hand-held |
|---|---|---|
| Highway Driving | 6.91 | 2.07 |
| City Driving | 2.42 | 1.87 |
| Parked | 1.06 | 0.98 |
| Indoor | N/A | 0.96 |
| Outdoor | N/A | 8.58 |

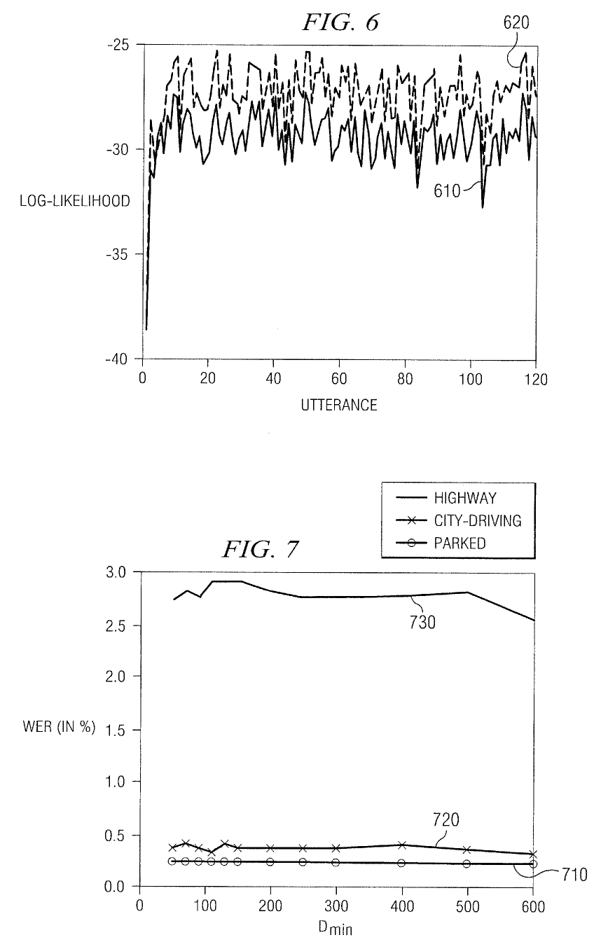

Next, the performance of SEC was evaluated as a function of clusters. A threshold Dₘᵢₙ controls the number of clusters for cluster-dependent biases. Dₘᵢₙ and the number of clusters bear an inverse relationship; the larger the Dₘᵢₙ, the fewer the clusters. FIG. 7 plots WERs by SEC versus Dₘᵢₙ. The curve 710 is for the parked condition; the curve 720 is for the city-driving condition; and the curve 730 is for the highway-driving condition. It may be observed that WERs do not vary much over a wide range of Dₘᵢₙ. However, WERs decreased slightly under highway and city driving conditions with increased Dₘᵢₙ. This suggests that it may be beneficial to adjust Dₘᵢₙ according to signal-to-noise ratio (SNR).

Next, the forgetting factor p and threshold Dₘᵢₙ were dynamically adjusted. The threshold Dₘᵢₙ was set to be smaller with the increase of SNR, i.e.:

$${D}_{min} = {D}_{0} + \frac{{D}_{1} - {D}_{0}}{{η}_{1} - {η}_{0}} ( {η}_{1} - η ) , \qquad ( 57 )$$

where η is the SNR of the current utterance. D₁ and D₀ are respectively the maximum and the minimum of the threshold Dₘᵢₙ. η₁ and η₀ each denote empirically set maximum and minimum SNRs. The forgetting factor ρ is similarly adjusted according to the SNR η.

$$ρ = {ρ}_{0} + \frac{{ρ}_{1} - {ρ}_{0}}{{η}_{1} - {η}_{0}} ( {η}_{1} - η ) , \qquad ( 58 )$$

where ρ₁ and ρ₀ each denote the maximum and the minimum of the forgetting factor ρ.

The parameters varied were D₀, D₁, ρ₀ and ρ₁. Table 4 shows WERs that result as these parameters were changed.

TABLE 5
WER of WAVES Name Recognition Achieved by SBC
with Various ρ₁ and D₁. D₀ = 50.

| | | ρ₁/D₁ | | | |
|---|---|---|---|---|---|
| ρ₀ | | (1.0/800) | (1.0/700) | (1.0/600) | (1.0/500) |
| 0.7 | Highway Driving | 2.67 | 2.59 | 2.85 | 2.85 |
| | City Driving | 0.22 | 0.22 | 0.22 | 0.22 |
| | Parked | 0.22 | 0.22 | 0.22 | 0.22 |
| 0.6 | Highway Driving | 2.73 | 2.61 | 2.77 | 2.83 |
| | City Driving | 0.22 | 0.22 | 0.22 | 0.22 |
| | Parked | 0.22 | 0.22 | 0.22 | 0.22 |
| | | ρ₁/D₁ | | | |
| ρ₀ | | (0.9/800) | (0.9/700) | (0.9/600) | (0.9/500) |
| 0.7 | Highway Driving | 2.73 | 2.57 | 2.89 | 2.79 |
| | City Driving | 0.18 | 0.18 | 0.22 | 0.22 |
| | Parked | 0.22 | 0.22 | 0.22 | 0.22 |
| 0.6 | Highway Driving | 2.85 | 2.89 | 3.05 | 2.91 |
| | City Driving | 0.22 | 0.22 | 0.22 | 0.22 |
| | Parked | 0.22 | 0.22 | 0.22 | 0.22 |

From Table 4, it may be observed that WERs by SBC did not vary much as D₀, D₁, ρ₀ and ρ₁ were changed. Nevertheless, the lowest WERs were achieved with same setup of ρ₀=0.7 and D₁=700. When ρ₁=1.0, 2.59%, 0.22% and 0.22% WERs resulted under highway driving, city driving and parked conditions, respectively. When ρ₁=0.9, 2.57%, 0.18% and 0.22% WERs resulted under highway driving, city driving and parked conditions, respectively.

Although the present invention has been described in detail, those skilled in the art should understand that they can make various changes, substitutions and alterations herein without departing from the spirit and scope of the invention in its broadest form.

What is claimed is:

1. A system for noisy automatic speech recognition, comprising:
a background noise estimator configured to generate a current background noise estimate from a current utterance;
an acoustic model compensator associated with said background noise generator and configured to use a previous channel distortion estimate and said current background noise estimate to compensate acoustic models and recognize a current utterance in said speech signal;
an utterance aligner associated with said acoustic model compensator and configured to align said current utterance using recognition output;
a channel distortion estimator associated with said utterance aligner and configured to generate a current channel distortion estimate from said current utterance; and
a bias estimator associated with said channel distortion estimator and configured to generate at least one cluster-dependent bias term from said current utterance.

2. The system as recited in claim 1 wherein said channel distortion estimator is further configured to employ a discounting factor.

3. The system as recited in claim 1 wherein said background noise estimator, said channel distortion estimator, and said bias estimator are further configured to employ forgetting factors.

4. The system as recited in claim 1 wherein said utterance aligner is further configured to obtain sufficient statistics for each state, mixture component and frame of said current utterance.

5. The system as recited in claim 1 wherein said background noise estimator configured to generate said current background noise estimate from non-speech segments of said current utterance.

6. The system as recited in claim 1 wherein said background noise estimator, said channel distortion estimator, and said bias estimator are configured to employ an E-M-type algorithm.

7. The system as recited in claim 1 wherein said channel distortion estimator is further configured to use a priori knowledge of channel distortion.

8. The system as recited in claim 1 wherein said bias estimator is further configured to use a binary tree.

9. The system as recited in claim 1 wherein said system is embodied in a digital signal processor of a mobile telecommunication device.

10. A method of noisy automatic speech recognition, comprising:
generating a current background noise estimate from a current utterance;
using a previous channel distortion estimate and said current background noise estimate to compensate acoustic models and recognize a current utterance in said speech signal;
aligning said current utterance using recognition output;
generating a current channel distortion estimate from said current utterance; and
generating at least one cluster-dependent bias term from said current utterance.

11. The method as recited in claim 10 wherein said generating said current channel distortion estimate comprises employing a discounting factor.

12. The method as recited in claim 10 wherein said generating said current background noise estimate, said generating said current channel distortion estimate and said generating said at least one cluster-dependent bias term each comprise employing forgetting factors.

13. The method as recited in claim 10 wherein said aligning comprises obtaining sufficient statistics for each state, mixture component and frame of said current utterance.

14. The method as recited in claim 10 wherein said generating said current background noise estimate comprises generating said current background noise estimate from non-speech segments of said current utterance.

15. The method as recited in claim 10 wherein said generating said current background noise estimate, said generating said current channel distortion estimate and said generating said at least one cluster-dependent bias term each comprise employing an E-M-type algorithm.

16. The method as recited in claim 10 wherein said generating said current channel distortion estimate comprises using a priori knowledge of channel distortion.

17. The method as recited in claim 10 wherein said generating said current bias term estimate comprises using a binary tree.

18. The method as recited in claim 10 wherein said method is carried out in a digital signal processor of a mobile telecommunication device.

19. A digital signal processor, comprising:
data processing and storage circuitry controlled by a sequence of executable instructions configured to:
generate a current background noise estimate from a current utterance;
use a previous channel distortion estimate and said current background noise estimate to compensate acoustic models and recognize a current utterance in said speech signal;
align said current utterance using recognition output;
generate a current channel distortion estimate from said current utterance; and
generate at least one cluster-dependent bias term from said current utterance.

20. The digital signal processor as recited in claim 19 wherein said sequence of executable instructions is further configured to employ a discounting factor to generate said current channel distortion estimate.

21. The digital signal processor as recited in claim 19 wherein said sequence of executable instructions is further configured to employ forgetting factors to generate said current background noise estimate, generate said current channel distortion estimate and generate said at least one cluster-dependent bias term.

22. The digital signal processor as recited in claim 19 wherein said sequence of executable instructions is further configured to obtain sufficient statistics for each state, mixture component and frame of said current utterance.

23. The digital signal processor as recited in claim 19 wherein said sequence of executable instructions is further configured to generate said current background noise estimate from non-speech segments of said current utterance.

24. The digital signal processor as recited in claim 19 wherein said sequence of executable instructions is further configured to employ an E-M-type algorithm to generate said current background noise estimate, generate said current channel distortion estimate and generate said at least one cluster-dependent bias term.
